(19) United States
(12) Patent Application Publication
(10) Pub. No.: US 2012/0311145 A1
(43) Pub. Date: Dec. 6, 2012

(54) METHOD AND SYSTEM TO MONITOR EQUIPMENT OF AN IT INFRASTRUCTURE

(75) Inventors: Srinivas Chervirala, Sunnyvale, CA (US); Satya Mallya, San Jose, CA (US); Venkat Banumukkala, Foster City, CA (US)

(73) Assignee: FRANCE TELECOM, Paris (FR)

(21) Appl. No.: 13/499,216

(22) PCT Filed: Sep. 27, 2010
(86) PCT No.: PCT/IB10/02630

§ 371 Date: Aug. 13, 2012

Related U.S. Application Data
(60) Provisional application No. 61/247,559, filed on Sep. 30, 2009.

(51) Int. Cl. G06F 15/173

(52) U.S. Cl. 709/224

(57) ABSTRACT

The present system relates to a method for rating an application by a user. The application is downloaded by the user from an application store server to his/her electronic device and is executable on the electronic device. The method includes, for the electronic device, the acts of monitoring application usage data for the application after a first execution of the application by the user, when the application usage data matches a predefined usage data criterion, sending a request to the user for evaluation of the application, and upon entry of an evaluation by the user, forwarding the entry to the application store server.

### FIELD OF THE PRESENT SYSTEM

The present system generally relates to applications running on an electronic device and more specifically to the evaluation of such applications.

### BACKGROUND OF THE PRESENT SYSTEM

With the success of an application market place like the Apple AppStore™, it is anticipated that Operators and Handset manufacturer will come up with application market places of their own. Application market places not only provide the visibility to developers and small 3rd party developers, but also provide an opportunity to reach users more directly than the more traditional cooperation with an Operator to get on board its generic device platform. However, the exponential growth of applications available on market places creates the problem of discovery of interesting applications for most users.

A device user, such as a mobile phone user, or mobile user in short, has to rely heavily upon rating systems to discover the popular applications in the market place. The discovery ends up biased as the current rating systems of all application market places are flawed. Indeed anyone can review and rate a given application, opening the possibility of reviews and rating from so called users who may not have used and experienced that application. These “non-users” can either be developers/editors, pushing the rating higher to attract more users to their latest applications. The ratings can also be biased through bashing of an application by competitors offering a similar application and seeking an edge with improper rating.

Using the example of the Apple AppStore™, a user can seek through Itunes™ on his computer for instance or through the AppStore™ application on his iPhone™ an application through a keyword search. When an application is found, the user can actually provide an evaluation and a rating, without any check of his knowledge of the application. A similar situation occurs when a user has downloaded an application from the AppStore™ and ends up removing it after a while. The removal will cause the Operating System of his iPhone™ to send a popup window requesting a rating of the application. As a lot of users tend to download as many applications as they can, cleaning up their smart phone interface will cause the removal of unused applications. If he answers the popup request, a user may end up rating applications he does not even know.

Existing solutions can be found for online stores like Ebay™, where a user is evaluated by other users. A well rated user will tend to provide valuable information while an unpopular one can be discarded more easily. Nevertheless these solutions are for vendors and do not take into account the specific nature of an application. Another existing solution can be found for online music. A popularity index can also be found on Itunes™ next to each media available for download. But that popularity index is just an indication of how many times the media has been downloaded overall.

There is still a need today for an improved method to rate and/or evaluate applications available from application market places. There is a further need for a rating system that avoids biased results.

### SUMMARY OF THE PRESENT METHOD AND SYSTEM

It is an objective of the present method and system to overcome disadvantages and/or make improvements in the prior art.

To that extend, the present method relates to a method for rating an application by a user, said application being downloaded by said user from an application store server to an electronic device of the user, said application being executable on said electronic device, the method comprising for said electronic device the acts of:
monitoring application usage data for the application after first execution of said application by the user,
when the application usage data matches a predefined usage data criterion, sending a request to said user for evaluation of the application,
upon entry of an evaluation by said user, forwarding said entry to the application store server.

Thanks to the present method, application usage data is first monitored on the electronic device and it is only when the application usage data matches a predefined usage data criterion that the user is requested for an evaluation. As the user can be considered as a true user of the application, since his application usage data shows an actual usage of the application, he can gives a feedback valuable to the application market place hosted on the application store server.

The present system also related to an electronic device for rating an application, said application being downloaded by a user of said electronic device from an application store server to said electronic device, the electronic device comprising a processor for executing the application, said processor being arranged to:
monitor application usage data for the application after first execution of said application by the user,
when the application usage data matches a predefined usage data criterion, send a request to said user for evaluation of the application,
upon entry of an evaluation by said user, forward said entry to the application store server.

The present system also relates to a telecommunication system comprising:
an application store server for providing applications to electronic devices,
an electronic device for rating an application, said application being downloaded by a user of said electronic device from the application store server to said electronic device, the electronic device comprising a processor for executing the application, said processor being arranged to:
monitor application usage data for the application after first execution of said application by the user,
when the application usage data matches a predefined usage data criterion, send a request to said user for evaluation of the application,
upon entry of an evaluation by said user, forward said entry to the application store server.

The present system also relates to a computer readable carrier including computer program instructions that cause a computer to implement a method for rating an application by a user, said application being downloaded by said user from an application store server to the computer, said application being executable on said computer, the readable carrier comprising:
instructions for monitoring application usage data for the application after first execution of said application by the user,
when the application usage data matches a predefined usage data criterion, instructions for sending a request to said user for evaluation of the application,
upon entry of an evaluation by said user, instructions for forwarding said entry to the application store server.

### BRIEF DESCRIPTION OF THE DRAWINGS

The present system and method are explained in further detail, and by way of example, with reference to the accompanying drawings wherein:

FIG. 1 shows an exemplary embodiment of the present system,

FIG. 2 shows an additional exemplary embodiment of the present system,

FIG. 3A shows an exemplary embodiment of the present method, in accordance with the exemplary embodiment of FIG. 2, and;

FIG. 3B shows an exemplary flowchart of the present method, in accordance with the exemplary embodiment of FIG. 2, and;

FIG. 4 shows another exemplary embodiment of the present system.

### DETAILED DESCRIPTION OF THE PRESENT SYSTEM

The following are descriptions of exemplary embodiments that when taken in conjunction with the drawings will demonstrate the above noted features and advantages, and introduce further ones.

In the following description, for purposes of explanation rather than limitation, specific details are set forth such as architecture, interfaces, techniques, etc., for illustration. However, it will be apparent to those of ordinary skill in the art that other embodiments that depart from these details would still be understood to be within the scope of the appended claims.

Moreover, for the purpose of clarity, detailed descriptions of well-known devices, systems, and methods are omitted so as not to obscure the description of the present system. Furthermore, routers, servers, nodes, base stations, gateways or other entities in a telecommunication network are not detailed as their implementation is beyond the scope of the present system and method.

For purposes of simplifying a description of the present system, the terms “operatively coupled”, “coupled”, and formatives thereof as utilized herein refer to a connection between devices and/or portions thereof that enables operation in accordance with the present system. For example, an operative coupling may include one or more of a wired connection and/or a wireless connection between two or more devices that enables a one and/or two-way communication path between the devices and/or portions thereof. For example, an operative coupling may include a wired and/or wireless coupling to enable communication between an application market server and one or more user devices.

Unless specified otherwise, the exemplary embodiment here after will be described in its application to a mobile device operable to select and download via a telecommunication network applications from an application market place. An application market client hosted by said mobile device may be used to facilitate the selection and download of applications.

The present exemplary embodiment is in no way a limitation of the scope of the present method and system as the present teachings could be implemented for other electronic devices, such as computers, laptops, PDAs (Personal Digital Assistants), set top box. More generally any electronic device having connection means for accessing distant application market servers over a telecommunication network for downloading applications may benefit form the present teachings.

The expressions application or application program (AP) in the present description may be taken in a very general sense, and may be seen as any tool that functions and is operated by means of a computer, with the purpose of performing one or more functions or tasks for a user or another application program. To interact with and control an AP, a GUI of the AP may be displayed on the mobile device display.

In addition, it should be expressly understood that the drawings are included for illustrative purposes and do not represent the scope of the present system.

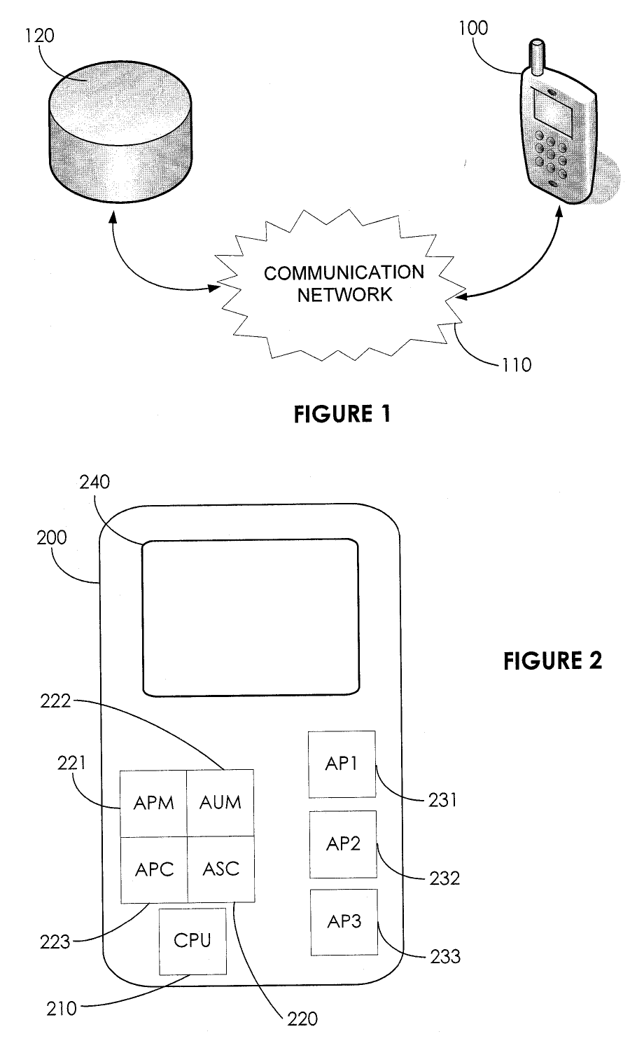

FIG. 1 shows an illustration of an exemplary embodiment of the present system. A telecommunication device 100, illustrated as mentioned before as a mobile device, may access through a telecommunication network 110 to an application market store (or place) hosted by an application market server 120. The Apple AppStore™ is a known example of such an application market place. Such a server 120 may store a large number of applications that can be downloaded to the mobile device 100 over telecommunication network 110, and subsequently invoked and operated on said mobile device. Today a large number of such applications are available and can performs tasks varying from games, location based services, call services, news, social network interfaces to music and video players and the likes. Two large categories of applications may be distinguished, namely:
online applications, i.e. applications that require internet or data connectivity to access remote databases and servers to perform one or more functions. They generally work on a client-server basis. These functions may also require offline computing on the mobile device 100. A map application for instance falls in that category, a newspaper application like the New York Times application is another example. A specific type of online application is a web application or webapp in short. These applications generally function within a web browser running on the mobile device,
offline applications, i.e. applications that do not need internet or data connectivity to operate. This can be for instance a game with only one player, a calculator, a voice recorder . . . . The menu of a mobile device may also be seen as an application program for controlling the device by the user.

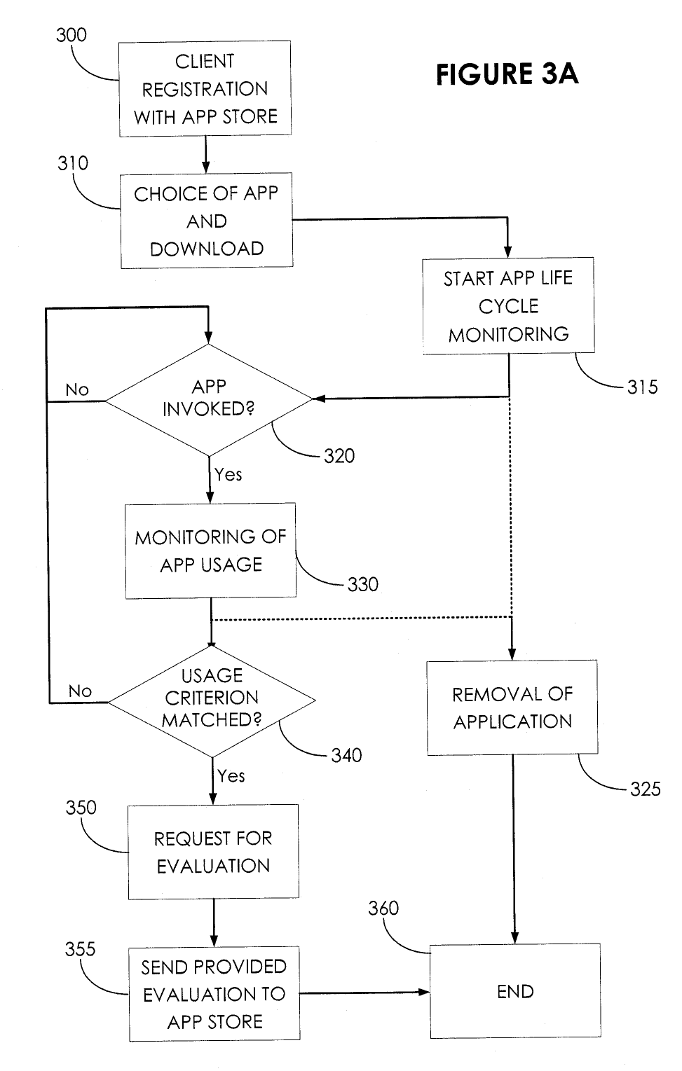

FIG. 2 is an illustration of another exemplary embodiment of the present system. Mobile device 200 may comprise a display 240 for presenting a Graphical User Interface (GUI) of an application program to a user of this device. A processor 210 (or Computational Processing Unit) is also provided for controlling and rendering the GUI presented to the display 240. The display 240 may be a touch panel. Touch panel 240 can be seen as an input device allowing interactions with a finger of a user or other devices such as a stylus. Such an input device can, for example, be used to make selections of portions of the GUI. The input received from a user's touch is sent to the processor 210 that interprets the touches in accordance with the application program corresponding to the GUI. For example, the processor 210 can initiate a task, i.e. a control of the AP, in accordance with a particular touch. More generally, processor 210 is provided for running the Operating System (OS) of the mobile device 200.

A touch panel or keyboard, or keypad (not shown in FIG. 2) may also be provided to control one or more APs running of the processor 210 of mobile device 200.

An application store client 220 (ASC) may be provided for interaction with the application market place 120 of FIG. 1. Such a client, like the AppStore™ client available today on an iPhone™, will allow the user to search and browse the different applications available for download. This ASC 220 will also deal with payments for applications that necessitate a payment from the user prior to download. In the present illustration of FIG. 2, a number of applications, for instance AP1 231, AP2 232 and AP3 233 have been downloaded on the mobile device 200 by the user.

Thanks to the present system, only true users of an application can provide some feedback to the application market place 120 which provided that given application to the user's electronic device. By a true user of an application, one may understand a user of a mobile device who both:
downloaded the application on his device. Hence the non-users in the existing solutions who simple provide online comments about applications they don't even know, will not be regarded as users allowed for comments and/or ratings,
uses the application. Thanks to the present system, the application usage data is measured. Application data usage for a user will increase as the application is used, i.e. executed by the user. In the present system, it is only when the application data usage matches a predefined usage data criterion that the user is considered a true user.

The data usage may be measured through different means such as:
the amount of time the application is run, i.e. executed on the mobile,
the amount of data consumed by the application itself, when the application is an online application, over a data connection for instance with a distance server,
the number of modules invoked by the user when the application comprises a plurality of modules. An example of such an application could be for instance a media player that provides a music module for listening to music, a video module for watching videos, a purchase module for buying new media, a radio module for listening to different radio channels . . . . With such an example, the user may become a true user if he has used at least 4 modules out of the various modules of the media player.

As seen later on, a combination of the different types of measurements may be used to determine the data usage.

In order to measure the usage data for an application, the present mobile device 200 may further comprise an application monitoring client (AMC) for monitoring the usage data of this application throughout its life cycle on the mobile device 200. The AMC may be provided with the ASC 220, for instance encapsulated with the ASC for direct use by the user when getting the mobile device 200. Alternatively, the AMC may be a stand alone application downloaded from the application market place over the telecommunication network.

The present AMC may comprise a number of parts or components in the present system as follows:
an application manager 221 or APM part, for monitoring the downloaded applications life cycle on the device. APM 221 if required will interact with the mobile device OS and the ASC 220 to monitor any action performed by the user with, or events caused by, these downloaded applications. This could be for instance updates, like the download of any new application or the removal from the mobile device. Other actions could be for instance invoking the application for execution on the device and/or that data is required by the application over the internet (online app). This could also the monitoring of the different application modules invoked by the user, when the application comprises a plurality of such modules. The execution e.g. will trigger the data usage measurement,
an application usage manager 222 or AUM part, to collect application usage data for each application of the mobile device 200. To do so, AUM 222 may track the application events by listening to the APM 221. The AUM 222 may use an application identifier to keep track each application data usage. For instance the AUM 222 may keep track of a given application running time, or get from the network interface card of the mobile device the data consumed by this given application. the AUM 222 may also determine the number of modules available for a given application and keep track of the application modules invoked by the user over time,
an application cache 223 or APC for storing for each application downloaded from the application market place usage data as collected and measured by the AUM 222. The usage data may be saved periodically or each time an application event or an action by the user in relation to the application occurs.

One may note that illustrating the AMC as a three part client is a mere illustration highlighting the different functionalities of the present AMC. This is in no way limiting as the three parts may be one of the same software or hosted on different elements of the mobile device 200.

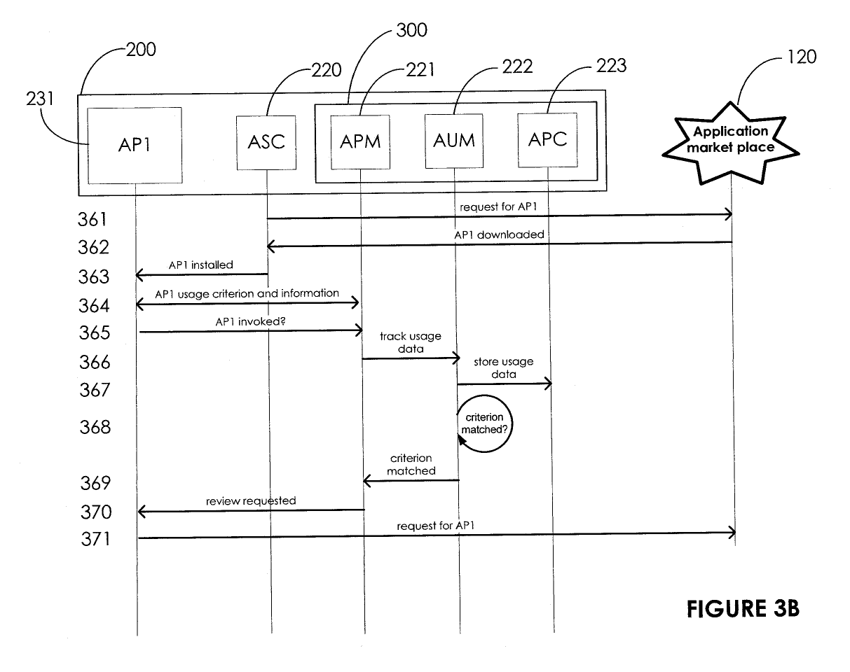

FIG. 3A is an illustration of an exemplary embodiment of the present method. In a preliminary act 300, the user of the mobile device 200 will register with an application market place like the AppStore™ for instance. This registration will give the user access to all applications available for download to his mobile device 200. The registration and downloads may be performed thanks to a data connection over the telecommunication network 110, for instance using a web browser or the application store client ASC 220.

The user then may browse the application market place for new applications or use search tools, like keywords tool, category searches, most popular applications . . . . The user may select an application, say for instance AP1 231 of FIG. 2, and download it to his device in a further act 310.

In a subsequent act 315, the application manager APM 221 is informed of the new download (e.g. by the OS of the mobile device) and will start to monitor for this newly downloaded AP1 its life cycle. The here after illustration will be described with only one monitored application AP1 for simplification purposes. This monitoring of AP1 life cycle may comprise all actions performed by the user with—and/or events caused by—the downloaded application. For instance, in a further act 320, the APM will check if the user has invoked the new downloaded application, i.e. has requested execution of AP1 on his mobile device. Provided AP1 is not yet invoked (answer No to act 320), the APM 221 will keep on monitoring any triggering of AP1 by repeating periodically for instance the act 320 as long as AP1 is not invoked/triggered by the user.

Provided the user invokes AP1 for the first time (answer Yes to act 320), i.e. after first execution of AP1 by the user, the APM 221 will inform the application usage manager AUM 222 to monitor the application usage data for AP1 (act 330). Usage data as mentioned before corresponds to actual usage of the application by the user. Application usage data can be of different types as mentioned before, e.g. at least one of the running time of the application (i.e. from first execution), the amount of data consumed by the application (if an online application) and number of application modules invoked by the user. The application usage data for AP1 will be set to zero. Each type of application usage data may be monitored separately, and an application usage data counter may be set to zero for each type of application usage data in act 330.

The AUM 222 will collect the application usage data and may save the measured usage data for AP1 periodically with the application cache APC 223. To collect the usage data, the AUM 222 may listen to the APM 221 for any events leading to:
more running time of AP1, and measured using the variable AUD_running_time,
more data consumption by AP1, and measured using the variable AUD_data_consumed
another module invoked by the user, and measured using the variable AUD_module_invoked.

Indeed the application usage data may be collected over discontinued periods of usage of AP1 by the user. The application usage data will increase each the user invokes and uses AP1. Using the hereabove different types of application usage data, the measured application usage data may be a vector of one, two or three values depending on the choice of data usage that is monitored, as illustrated in Matrix 1:

$$Matrix 1 \text{:} example of an application usage data matrix \\ [ \begin{matrix}AUD\_running \_time \\ AUD\_data \_consumed \\ AUD\_modules \_invoked\end{matrix} ]$$

More values may be readily added by the man skilled in the art, like for instance, the number of times the user starts the application, if other application usage data are defined to better characterize a true user.

In a further act 340, the AUM 222 will compare the usage data to a predefined usage data criterion. The checking act 340 may be performed periodically or each time the usage of AP1 is discontinued for instance.

The predefined usage data criterion may be defined identical for all applications. For instance if the running time is the only application usage data measured, the criterion could be matched if the running time exceeds a predefined running time threshold identical for all downloaded applications.

Alternatively, a predefined usage data criterion may be provided by the application market place each time an application is downloaded. Using the matrix example of Matrix 1, such a criterion may be defined as:

$$Matrix 2 \text{:} predefined usage criterion example [ \begin{matrix}AUD\_running \_time \leq running\_time \_threshold \\ AUD\_data \_consumed \leq data\_consumed \_threshold \\ AUD\_modules \_invoked \leq modules\_invoked \_threshold\end{matrix} ]$$

Depending on the number of monitored type of application usage data, each monitored application usage data may be compared to a predefined usage data threshold value to check if the criterion is matched.

As characteristics of applications vary from one application to the other, a usage data threshold may be defined and provided by the application market place. In other words, the application usage data threshold may be application based to determine whether a user is a true user. For instance, for game applications, the predefined usage data threshold, using the running time type of application usage data, may correspond to a total running time. As the usage data threshold can be set to show a significant usage by the user/player of the game, it can vary significantly from one game to the other. A Sudoku game will require a lot more running time to truly appreciate the application while a simple Tic-Tac-Toe application will be almost instantly mastered by the user. In an additional embodiment of the present method, the predefined usage data criterion comprises the comparison of the application usage data to a predefined usage data threshold, that is application dependent and downloaded with the application from the application market place.

The same remark can be said of online applications, as some applications may consume large amount of data, like a map application, while other may only require limited data from the telecommunication network. Weather applications for instance only require temperatures and weather conditions over a few days, and the weather application will translate these data locally into a GUI that the user can easily read. A map based application will require large volumes of data from a geoserver providing maps and itinerary information for instance.

For some applications it may be interested to define a usage data criterion based on two or more usage data types. This corresponds to the exemplary illustration of Matrix 2 here above with 3 types of application usage data monitored. The predefined usage data threshold, defined as a triplet of values, will be exceeded only when all three conditions of the Matrix 2 are matched, i.e. that AUD_running_time, AUD_data_consumed and AUD_module_invoked all exceed their respective predefined threshold. In other words, all conditions of Matrix 2 must be matched before defining the user as a true user.

Alternatively, only one of the conditions of Matrix 2 may be matched to define that the user is a true user reliable for providing a feedback on AP1. The man skilled in the art may defined more or less complex usage data criterion to better apprehend the true usage of an application. Indeed, depending on the types of application usage data monitored, the size of Matrix 2 may vary from just a single check to 3 (in the illustrated example) or more.

Provided the predefined usage data criterion is not matched (answer No to act 340), the AUM 222 will keep on listening to the APM 221 for events and actions (acts 320 and 330) to measure more usage data for AP1. Event when the application AP1 is not executed for a long period of time, usage data are saved by the AUM 222 in the APC 223, in relation to an AP1 identifier, and the present usage data measurement will resume if AP1 is invoked again.

Provided the predefined usage data criterion is met (answer Yes to act 340), the user of AP1 can be now considered as a true user, and thus a request for evaluation can be presented to the user in a further act 350. This may come in the form of a popup window while the application is running (if the act 340 is for instance carried out while the application is currently running) or after AP1 is stopped by the user (i.e. if the act 340 is carried out each time AP1 is stopped by the user).

Once the user has entered an evaluation, the present application monitoring client will forward this evaluation to the application market place in a further act 355. The present method can end in a further act 360.

The user of the mobile device 200 may opt to remove AP1 in an act 325. As the APM 221 can also monitor such events like the removal of an application, provided it is removed prior to any invocation (i.e. prior to any usage of the application, dotted line from act 315 and 325 on FIG. 3A), the present method will end in the act 360, skipping the request for evaluation. If the removal 325 is requested prior to reaching the usage threshold (dotted line after act 330 to act 325), the present method will also end with act 360. This is an illustration that only true users can provide in the present system a rating and/or an evaluation of AP1.

By collecting all evaluations and ratings from the true users, the application market place can present interesting information to potential users. The collected evaluations are no longer biased as only the true users are requested for their opinions.

FIG. 3B is another flowchart illustrating an exemplary embodiment of the present method. The different elements mentioned before are shown in FIG. 3B. As such the mobile device 200 may comprise:
the application store client ASC 220, to download the applications from the application market place 120,
the application monitoring client AMC 300 to monitor application usage data over the application lifecycle on the mobile device 200, itself comprising:
   the application manager APM 221,
   the application usage manager AUM 222,
   the application cache APC 223, all defined before.

The application market place is illustrated through the application market server 120 as in FIG. 1.

In a preliminary act 361, the user will request AP1 from the application market place through the ASC 220 provided on this mobile device 200. As mentioned before, the request can be made through a browser interface and the likes. The ASC 220 will receive AP1 231 (the registration and payment are skipped for simplification purposes as beyond the scope of the present method) in a subsequent act 362, and AP1 will be installed on the device 200 (act 363). AP1 usage data criterion may be collected by the APM 221 in a further act 364 when detecting that a new application has been downloaded. Other parameters for AP1 can be collected at this stage 364 by APM manager, like the number of modules, or the type of application (online/offline). For instance, if the APM manager determines that AP1 is an online application that requires a number N_modules of modules, it will know that 3 types of application usage data can be monitored and the usage data criterion may come in the exemplary form of Matrix 2 mentioned before.

In a further act 365, APM 221 will monitor if AP1 is invoked (Yes to act 365), and when it is executed for the first time by the user, it will request the AUM 222 to start monitoring application usage data for AP1 in an additional act 366. Based on the AP1 parameters collected before, APM 221 will instruct through this act 366 the AUM 222 to collect any application usage data for one or more types of data usage, as explained in relation to FIG. 3A. If the usage is discontinued, application usage data may be stored in the APC 223 periodically or each time AP1 is ended (act 367). AUM 222 will check if the predefined usage data criterion is matched/met in a further act 368, either during execution of the application for instance or when the application is ended by the user.

When the predefined usage data criterion is matched (answer Yes to act 368), the APM 221 will be informed by the AUM 222 with the subsequent act 369 and in a further act 370 of the present method, APM 221 will request a review to the user, through for instance a popup window on AP1. If would be interesting to chose the moment of sending the request for evaluation as the user could be disturbed while enjoying the application. In an additional embodiment of the present, APM 221 will delay the request until the application is ended or paused by the user.

Once the user has provided his evaluation, in the form or a rating or a comment for instance, the evaluation will be forwarded in a subsequent act 371 to the application market place.

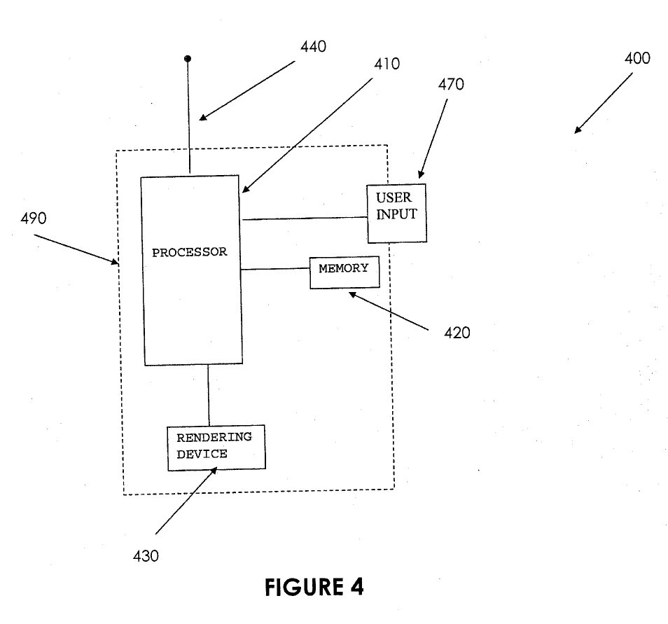

FIG. 4 shows a system 400 in accordance with an embodiment of the present system. The system 400 includes a mobile device node 490 hosting application monitoring client. Mobile node 490 has a processor 410 operationally coupled to a memory 420, a rendering device 430, such as one or more of a display, speaker, etc., a user input device 470, such as a sensor panel, a keyboard, trackball and the likes, and a connection 440 operationally coupled to other entities and nodes of a telecommunication network 110 (not shown in FIG. 4). The connection 440 may be an operable connection between the mobile node 490 and another node, server or device that has similar elements as mobile node 490, such as the application market place hosted by an application market server.

The memory 420 may be any type of device for storing for instance the application data related to the operating system of the mobile node, as well as to application data in accordance with the present method. The application data are received by the processor 410 for configuring the processor 410 to perform operation acts in accordance with the present system. The operation acts include:

monitoring application usage data for the application after first execution of said application by the user,

when the application usage data matches a predefined usage data criterion, sending a request to said user for evaluation of the application,

upon entry of an evaluation by said user, forwarding said entry to the application store.

The user input 470 may include a sensor panel as well as a keyboard, mouse, trackball, touchpad or other devices, which may be stand alone or be a part of a system, such as part of a personal computer (e.g., desktop computer, laptop computer, etc.) personal digital assistant, mobile phone, converged device, or other rendering device for communicating with the processor 410 via any type of coupling, such as a wired or wireless coupling. The user input device 470 is operable for interacting with the processor 410 including interaction within a paradigm of a GUI and/or other elements of the present system, such as to enable entry of data by an operator.

Clearly the mobile node 490, the processor 410, memory 420, rendering device 430 and/or user input device 470 may all or partly be portions of a computer system or other device, and/or be embedded in one or more servers.

The system, device and method described herein address problems in prior art systems. In accordance with an embodiment of the present system, the mobile device may download an application from an application market place and its user may evaluate this downloaded application only when his application usage data matches a predefined usage data criterion.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 420 or other memory coupled to the processor 410.

The computer-readable medium and/or memory 420 may be any recordable medium (e.g., RAM, ROM, removable memory, CD-ROM, hard drives, DVD, floppy disks or memory cards) or may be a transmission medium utilizing one or more of radio frequency (RF) coupling, Bluetooth coupling, infrared coupling, etc. Any medium known or developed that can store and/or transmit information suitable for use with a computer system may be used as the computer-readable medium and/or memory 420.

Additional memories may also be used. These memories configure processor 410 to implement the methods, operational acts, and functions disclosed herein. The operation acts may include controlling the rendering device 430 to render elements in a form of a GUI and/or controlling the rendering device 430 to render other information in accordance with the present system.

Moreover, the term “memory” should be construed broadly enough to encompass any information able to be read from or written to an address in the addressable space accessed by a processor. With this definition, information on a network is still within memory 420, for instance, because the processor 410 may retrieve the information from the network for operation in accordance with the present system. For example, a portion of the memory like APC 223 as understood herein may reside on different nodes of the telecommunication network.

The processor 410 is capable of performing operations in response to incoming user actions with and control over the application, and executing instructions stored in the memory 420. The processor 410 may be an application-specific or general-use integrated circuit(s). Further, the processor 410 may be a dedicated processor for performing in accordance with the present system or may be a general-purpose processor wherein only one of many functions operates for performing in accordance with the present system. The processor 410 may operate utilizing a program portion, multiple program segments, or may be a hardware device utilizing a dedicated or multi-purpose integrated circuit.

Finally, the above discussion is intended to be merely illustrative of the present system and should not be construed as limiting the appended claims to any particular embodiment or group of embodiments. Thus, while the present system has been described with reference to exemplary embodiments of a mobile device, including user interfaces, it should also be appreciated that numerous modifications and alternative embodiments may be devised by those having ordinary skill in the art without departing from the broader and intended spirit and scope of the present system as set forth in the claims that follow. Indeed the present teaching may be transposable to any electronic device capable of running an application downloaded from an application market place, such as a general purpose computer, a PDA . . . . Further, while exemplary user interfaces are provided to facilitate an understanding of the present system, other user interfaces may be provided and/or elements of one user interface may be combined with another of the user interfaces in accordance with further embodiments of the present system.

The section headings included herein are intended to facilitate a review but are not intended to limit the scope of the present system. Accordingly, the specifications and drawings are to be regarded in an illustrative manner and are not intended to limit the scope of the appended claims.

In interpreting the appended claims, it should be understood that:

a) the words “comprising” or “including” do not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analogue and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

What is claimed is:

1. A method for rating an application by a user, said application being downloaded by said user from an application store server to an electronic device of the user, said application being executable on said electronic device, the method comprising for said electronic device the acts of:
monitoring application usage data for the application after first execution of said application by the user,
when the application usage data matches a predefined usage data criterion, sending a request to said user for evaluation of the application,
upon entry of an evaluation by said user, forwarding said entry to the application store server.

2. The method of claim 1, wherein the predefined usage data criterion is application dependent and downloaded from the application store server with the application.

3. The method of claim 1, wherein the application usage data comprises the application running time, the predefined usage criterion being matched when the application running time exceeds a predefined running time threshold.

4. The method of claim 1, wherein the application usage data comprises the data consumed by the application over a data connection with a distant server, the predefined usage criterion being matched when the data consumed exceeds a predefined consumed data threshold.

5. The method of claim 1, wherein the application comprises a first number of modules, the application usage data comprising the number of modules invoked by the user when executing said application, the predefined usage criterion being matched when the number of modules invoked by the user exceeds a predefined module threshold.

6. An electronic device for rating an application, said application being downloaded by a user of said electronic device from an application store server to said electronic device, the electronic device comprising a processor for executing the application, said processor being arranged to:
monitor application usage data for the application after first execution of said application by the user,
when the application usage data matches a predefined usage data criterion, send a request to said user for evaluation of the application,
upon entry of an evaluation by said user, forward said entry to the application store server.

7. The electronic device of claim 6, wherein the predefined usage data criterion is application dependent and downloaded from the application store server with the application.

8. The electronic device of claim 6, wherein the application usage data comprises the application running time, the predefined usage criterion being matched when the application running time exceeds a predefined running time threshold.

9. The electronic device of claim 6, wherein the application usage data comprises the data consumed by the application over a data connection with a distant server, the predefined usage criterion being matched when the data consumed exceeds a predefined consumed data threshold.

10. The method of claim 6, wherein the application comprises a first number of modules, the application usage data comprising the number of modules invoked by the user when executing said application, the predefined usage criterion being matched when number of modules invoked by the user exceeds a predefined module threshold.

11. A telecommunication system comprising:
an application store server for providing applications to electronic devices,
an electronic device for rating an application, said application being downloaded by a user of said electronic device from the application store server to said electronic device, the electronic device comprising a processor for executing the application, said processor being arranged to:
monitor application usage data for the application after first execution of said application by the user,
when the application usage data matches a predefined usage data criterion, send a request to said user for evaluation of the application,
upon entry of an evaluation by said user, forward said entry to the application store server.

12. A computer readable carrier including computer program instructions that cause a computer to implement a method for rating an application by a user, said application being downloaded by said user from an application store server to the computer, said application being executable on said computer, the readable carrier comprising:
instructions for monitoring application usage data for the application after first execution of said application by the user,
when the application usage data matches a predefined usage data criterion, instructions for sending a request to said user for evaluation of the application,
upon entry of an evaluation by said user, instructions for forwarding said entry to the application store server.
